(19) United States
(12) Patent Application Publication
(10) Pub. No.: US 2026/0239354 A1
(43) Pub. Date: Aug. 13, 2026

(54) METHOD AND APPARATUS FOR SELECTION OF A RADIO BEARER TYPE IN DUAL-CONNECTIVITY DEPLOYMENTS THAT SUPPORT AI/ML

(71) Applicant: Samsung Electronics Co., Ltd., Suwon-si, Gyeonggi-do (KR)

(72) Inventors: Morteza KHEIRKHAH, Staines (GB); Chadi KHIRALLAH, Staines (GB); Jonas SEDIN, Staines (GB)

(21) Appl. No.: 19/155,482

(22) PCT Filed: Feb. 8, 2024
(86) PCT No.: PCT/KR2024/001899

§ 371 Date: Aug. 11, 2025

(30) Foreign Application Priority Data
Feb. 10, 2023 (GB) 2301932.6
Jan. 9, 2024 (GB) 2400312.1

(51) Int. Cl. H04W 72/21; H04W 72/566

(52) U.S. Cl. CPC H04W 72/21; H04W 72/566

(57) ABSTRACT

The present disclosure relates to a 5G communication system or a 6G communication system for supporting higher data rates beyond a 4G communication system such as long term evolution (LTE). Disclosed is a method of performing bearer configuration for a particular class of data for a User Equipment, UE, communicatively coupled to a telecommunication network, wherein the bearer configuration is managed by the telecommunication network with or without assistance information from the UE, or by the UE itself.

### TECHNICAL FIELD

The present invention relates to selection of a radio bearer type in dual-connectivity deployments, particularly in deployments that support Artificial Intelligence/Machine Learning.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The present invention has been made to address at least the above problems and/or disadvantages and to provide at least the advantages described below. Accordingly, an aspect of the present invention provides a method and apparatus for selecting a radio bearer type in dual-connectivity deployment that support AI/ML.

### Solution to Problem

In accordance with an aspect of the disclosure, a method performed by a user equipment (UE) is provided. The method includes receiving, from an application function (AF), an indication for a high priority in an artificial intelligent (AI) or a machine learning (ML); based on the indication, determining a radio bearer (RB) associated with a secondary cell group (SCG) for the AI or the ML; and transmitting, to the secondary node (SN), uplink (UL) data over the RB associated with the SCG.

In accordance with an aspect of the disclosure, a method performed by a master node (MN) is provided. The method includes receiving, from a user equipment (UE), a request message for a secondary cell group (SCG) radio resources; and transmitting, to the UE, a radio resource control (RRC) message for configuring a radio bearer (RB) associated with the SCG for an artificial intelligent (AI) or a machine learning (ML), wherein the RB associated with the SCG is determined based on an indication for a high priority in the AI or the ML.

In accordance with an aspect of the disclosure, a user equipment is provided. The user equipment includes a transceiver; and a controller configured to receive, from an application function (AF), an indication for a high priority in an artificial intelligent (AI) or a machine learning (ML), based on the indication, determine a radio bearer (RB) associated with a secondary cell group (SCG) for the AI or the ML, and transmit, to the secondary node (SN), uplink (UL) data over the RB associated with the SCG.

In accordance with an aspect of the disclosure, a master node is provided. The master node includes a transceiver; and a controller configured to receive, from a user equipment (UE), a request message for a secondary cell group (SCG) radio resources, and transmit, to the UE, a radio resource control (RRC) message for configuring a radio bearer (RB) associated with the SCG for an artificial intelligent (AI) or a machine learning (ML), wherein the RB associated with the SCG is determined based on an indication for a high priority in the AI or the ML.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for method and network for selecting a radio bearer type in dual-connectivity deployment that support AI/ML.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows Control plane architecture, known in the prior art;

FIG. 2 shows Network side protocol termination options for MCG, SCG and split bearers in MR-DC with 5GC, known in the prior art;

FIG. 3 shows Radio Protocol Architecture for MCG, SCG and split bearers from a UE perspective in MR-DC with 5GC, known in the prior art;

FIG. 4 shows Network side protocol termination options for MCG, SCG and split bearers in MR-DC with EPC (EN-DC), known in the prior art;

FIG. 5 shows Radio Protocol Architecture for MCG, SCG and split bearers from a UE perspective in MR-DC with EPC (EN-DC), known in the prior art;

FIG. 6 shows UE state machine and state transitions in New Radio, NR, known in the prior art;

FIG. 7 shows Federated Learning interactions, known in the prior art;

FIG. 8 shows Performance gap vs. experience of learning for a given task, known in the prior art;

FIG. 9 shows examples of disturbance of data transfer within a preferred deadline of 1 sec (t=t0+1) with the data size of 3 bits, known in the prior art;

FIG. 10 shows a call flow according to an embodiment of the invention; and

FIG. 11 a call flow according to an embodiment of the invention.

FIG. 12 illustrates a user equipment (UE) in a wireless communication systems to which embodiments of the disclosure can be applied.

FIG. 13 illustrates a base station in a wireless communication system to which embodiments of the disclosure can be applied.

### MODE FOR THE INVENTION

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Embodiments find particular use in 5G systems, or systems incorporating 5G technology, but the skilled person will readily appreciate that other systems may also benefit from the teaching herein.

Multi-RAT (Radio-Access Technology) Dual Connectivity (MR-DC) is a general term to describe various Dual Connectivity (DC) scenarios with 5G system. An MR-DC technology permits an end device (e.g., smartphone, tablet, laptop, drone, robot, home broadband router, etc.) to connect to at least two cellular cell towers at the same time, utilizing different frequency bands (e.g., (Frequency Range 1) FR1 and (Frequency Range 2) FR2). Such a feature automatically provides a high data rate to end devices and flexibility in data transportation, which is an essential requirement for 5G and 6G use cases.

Apart from achieving a high data rate, better reliability and lower latency can also be achieved if proper data scheduling and traffic steering mechanisms are in place across these simultaneous, potentially heterogeneous cellular links to handle a diverse set of traffic that may be generated from different 5G/6G applications with distinct requirements and constraints.

There are several ways the MR-DC technology can be realized by the 3GPP system and that is mainly dependent on which 3GPP access and core network technologies are used (e.g., whether the core network is 5GC or Evolved Packet Core (EPC), and whether the access network supports eNB or gNB and their variants en-gNB or ng-eNB).

Example of MR-DC configurations include EN-DC (E-UTRA-NR Dual Connectivity), NR-DC (New Radio Dual Connectivity), NGEN-DC (NG-RAN-E-UTRA Dual Connectivity) and NE-DC (NR-E-UTRA Dual Connectivity). Across all deployment configurations, four different main bearer models have been considered by 3GPP. Each bearer model explains how data streams (user plane traffic) between UE and the core network (either EPC or 5GC) can flow through the RAN: (i) Master Cell Group (MCG) Bearer; (ii) MCG Split Bearer, (iii) Secondary Cell Group (SCG) Bearer and (iv) SCG Split Bearer.

In a DC deployment, one of the base stations becomes the Master node (MN) which terminates the core network connectivity. Once UE has been registered/connected to the network via the MN, it can connect to another base station called the Secondary node (SN). The SN can also terminate the core network connectivity, similar to the MN.

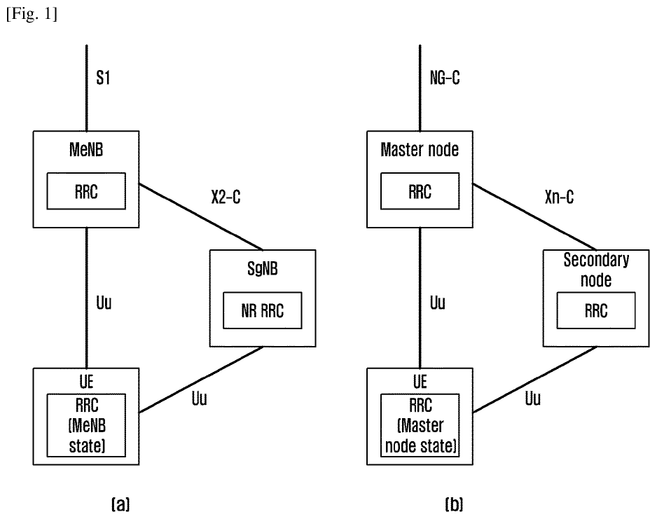

FIGS. 1a and 1b show, respectively, control plane architecture for EN-DC and MR-DC with 5GC. The MN and SN interact with one another via either X2 or Xn interfaces for exchanging both user plane and control plane (X2-C and Xn-C) traffic, depending on the deployment scenario (e.g., EN-DC or NR-DC, respectively).

In EN-DC or NR-DC, the UE has a single RRC state based on the MN RRC and a single control plane connection towards the CN. FIG. 1 illustrates the control plane architecture for MR-DC (i.e., EN-DC or NR-DC). Each radio node has its own RRC entity (E-UTRA version if the node is an eNB or NR version if the node is a gNB), which can generate RRC PDUs to be sent to the UE. The RRC PDUs generated by SN (i.e., SgNB in FIG. 1) can be delivered to UE via the MN (i.e., MeNB in FIG. 1). The MN always transports the initial SN RRC configuration via MCG Signal Radio Bearer (SRB1), but subsequent reconfigurations may be transported via MN or SN. When transporting RRC PDUs from the SN to UE via the MN, the MN does not modify the UE configuration provided by the SN.

If the SN is gNB, the UE can be configured to setup SRB3 with which the UE and SN can interact directly without needing to send some of their control plane signalling via MN.

Across all MR-DC scenarios, not only user plane but also control plane can be split, permitting duplication of RRC PDUs generated by the MN, via the direct path and via the SN. However, note should be taken that split SRB uses NR Packet Data Convergence Protocol (PDCP) only.

Across all DC scenarios with 5GC, the UE stores the PDCP/Service Data Adaptation Protocol (SDAP) configuration and the SCG configuration when transiting to the RRC INACTIVE state. During connection resumption, if the UE supports resuming with MR-DC, the UE can be configured to release, restore, or reconfigure the SCG configuration. Otherwise, it releases the SCG configuration. In the case of EN-DC, the SCG configuration is kept in the UE during the suspension. During connection resumption, if the UE supports resuming with EN-DC, the UE can be configured to release, restore, or reconfigure the SCG configuration. Otherwise, the UE releases the SCG configuration (not the radio bearer configuration) during resumption initiation.

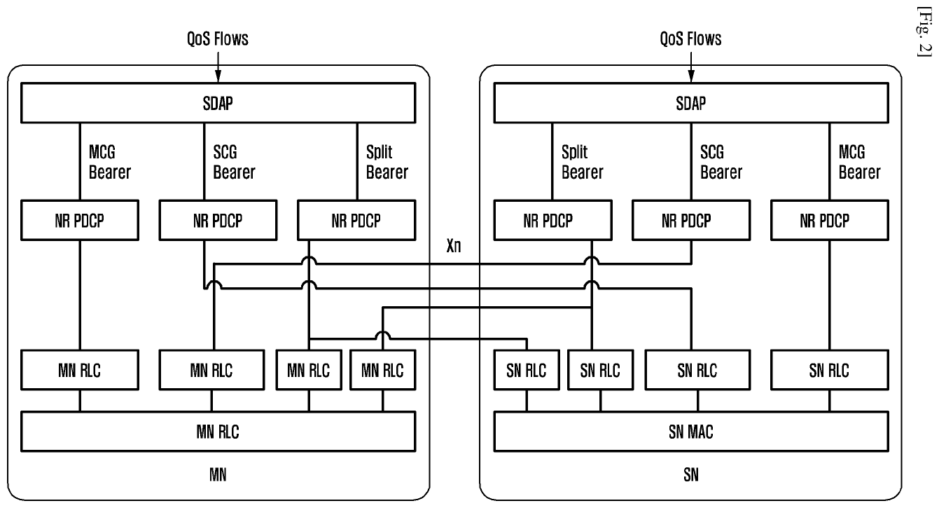

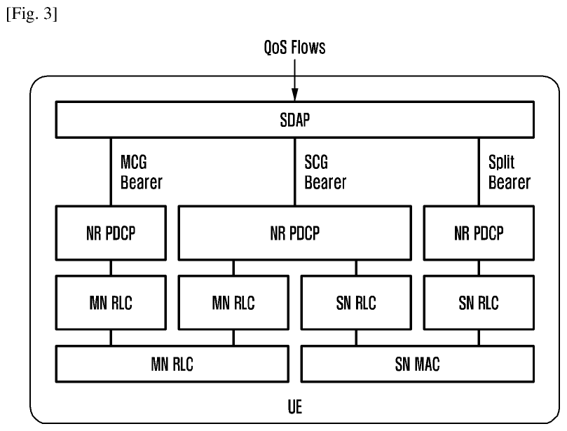

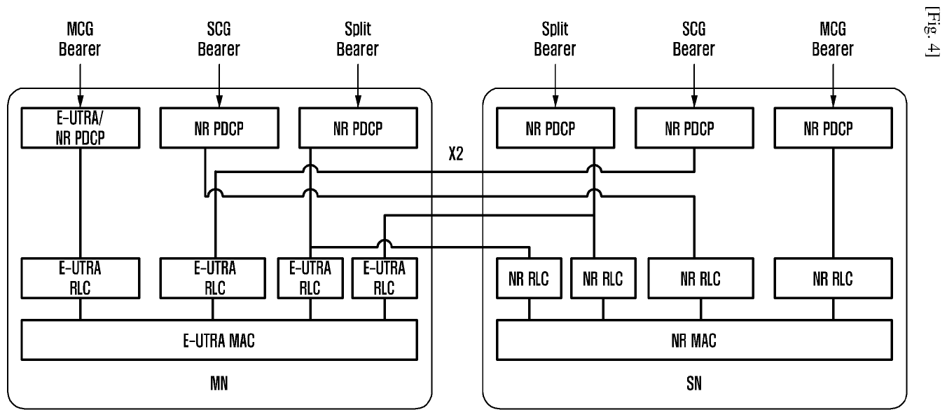

With NR-DC (New Radio Dual Connectivity), the core network is 5GC and base stations at the radio access network support only 5G New Radio technology (i.e., gNB). FIG. 2 illustrates NR-DC deployment with four different bearer models, as previously described. With the MCG Bearer model, the core network sends the UE's traffic to the Master Node (MN or MgNB). This way, the traffic is arrived at the SDAP layer of MN (shown in FIG. 3) and then it is passed down to the PDCP layer and so on. The MCG Split Bearer option follows similarly to the MCG Bearer (arrives at the MN), but it can split the traffic at the PDCP layer of the MN, where some traffic can be delivered to UE via the Secondary node (SN or SgNB).

The connectivity between the MN (MgNB) and the SN (SgNB) is through the Xn interface for carrying both user plane and control plane traffic. The split portion of traffic from MN arrives at the RLC layer of SN (i.e., SN RLC in FIG. 3). The SCG Bearer and the SCG Split Bearer options follow similarly the MCG Bearer and the MCG Split Bearer, respectively.

FIG. 3 shows the Radio Protocol Architecture for MCG, SCG and split bearers from a UE perspective in MR-DC with 5GC. A UE can connect to two cellular cells simultaneously. A MN can be a Macrocell, operating at lower frequency bands (e.g., sub-6-GHz; FR1 spectrums), which results in wider coverage. The SN can be a small cell operating at high-frequency bands (e.g., mmWave; FR2 spectrums), which results in a shorter coverage, but it provides extremely high bandwidth to UE.

A bearer model, shown in FIG. 3, can be used for downstream/upstream traffic to/from UE. This traffic can be used for the user plane or control plane. In the case of the control plane traffic, the RRC layer should replace the SDAP layer in FIG. 3. In the case of user plane traffic (i.e., QoS Flows), it is split at NR-PDCP towards two separate NR RLC instances.

It is important to highlight that the PDCP layer is to provide a sequence ordering of the incoming traffic by generating a Protocol Data Unit (PDU), which includes a sequence number in its header from the incoming traffic. This functionality permits the traffic to be reassembled with a correct ordering at the receiver if the PDCP PDUs arrive out-of-order due to the latency mismatch of different RATs involved in a DC scenario or PDU losses at the PHY layer.

With EN-DC deployment, the core network is EPC (Evolved Packet Core) instead of 5GC, and thus, the MN is eNB (MeNB) connecting to EPC. The SN (SgNB) is en-gNB (a gNB that can also support EPC). The SgNB connects to MeNB via the X2 interface, delivering both user plane and control plane traffic.

In MR-DC, the UE has a single RRC state, based on the MN RRC and a single C-plane connection towards the Core Network. FIG. 1 illustrates the Control plane architecture for MR-DC. Each radio node has its own RRC entity (E-UTRA version if the node is an eNB or NR version if the node is a gNB) which can generate RRC PDUs to be sent to the UE.

RRC PDUs generated by the SN can be transported via the MN to the UE. The MN always sends the initial SN RRC configuration via MCG SRB (SRB1), but subsequent reconfigurations may be transported via MN or SN. When transporting RRC PDU from the SN, the MN does not modify the UE configuration provided by the SN.

At initial connection establishment SRB1 uses E-UTRA PDCP. If the UE supports EN-DC, regardless whether EN-DC is configured or not, after initial connection establishment, MCG SRBs (SRB1 and SRB2) can be configured by the network to use either E-UTRA PDCP or NR PDCP (either SRB1 and SRB2 are both configured with E-UTRA PDCP, or they are both configured with NR PDCP). Change from E-UTRA PDCP to NR PDCP (or vice-versa) is supported via a handover procedure (reconfiguration with mobility) or, for the initial change of SRB1 from E-UTRA PDCP to NR PDCP, with a reconfiguration without mobility before the initial security activation.

If the SN is a gNB (i.e. for EN-DC, NGEN-DC and NR-DC), the UE can be configured optionally to establish a SRB with the SN (SRB3) to enable RRC PDUs for the SN to be sent directly between the UE and the SN. RRC PDUs for the SN can only be transported directly to the UE for SN RRC reconfiguration not requiring any coordination with the MN. Measurement reporting for mobility within the SN can be done directly from the UE to the SN if SRB3 is configured.

It is worth highlighting that UE and NG-RAN can be configured with multiple data bearers simultaneously to handle UE's traffic. For example, it is possible to use the MCG Bearer and the SCG Split Bearer to route a particular set of traffic only via eNB such as Voice traffic while also splitting Internet traffic via both eNB and gNB, at a finer granularity (e.g., at the packet level granularity). This also implies that splitting traffic across different bearer configurations can be done at the network core while splitting traffic through a single MCG/SCG Split Bearer configuration can be performed at the PDCP layer.

Note that splitting traffic at gNB may be preferred as it has more capabilities compared to eNB. In other words, the SCG Split Bearer may be a more desirable deployment option in an EN-DC deployment.

EN-DC is the most common Non-Standalone (NSA) 5G deployment, allowing 5G NR technology to be deployed alongside 4G infrastructure. There are other deployment variants similar to EN-DC, supporting Multi RAT DC (MR-DC) such as NGEN-DC (NG-RAN-E-UTRA DC) and NE-DC (NR-E-UTRA DC). The latter has a MN with Next Generation eNB (ng-eNB), so-called “Sng-eNB”, while the former has ng-eNB as the Secondary node, so-called “Sng-eNB”. With NGEN-DC and NE-DC the network core is 5GC.

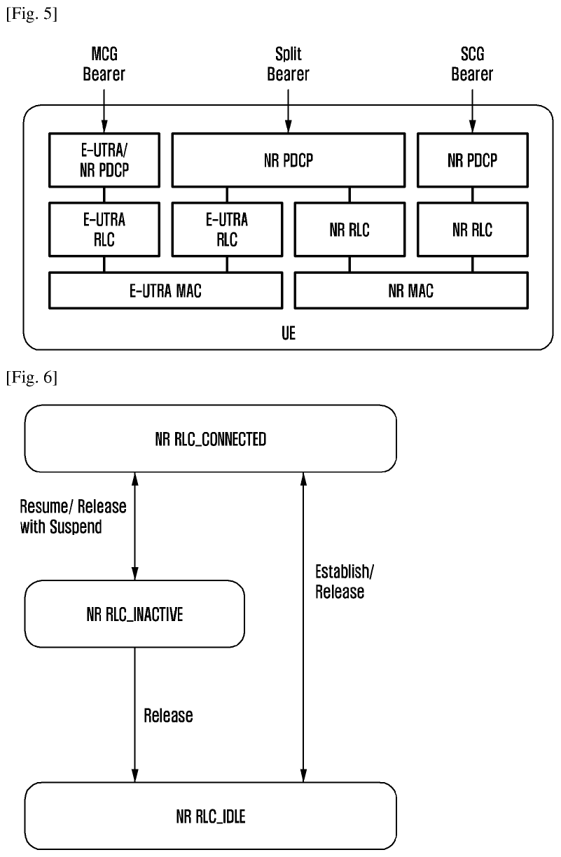

FIG. 5 shows Radio Protocol Architecture for MCG, SCG and split bearers from a UE perspective in MR-DC with EPC (EN-DC). With EN-DC, the MCG bearer could be handled by either E-UTRA PDCP or NR PDCP dependent on the configuration and UE's capability. A Split Bearer (e.g., MCG or SCG split bearer) can only be handled by NR PDCP as splitting is a new functionality of the NR. The SCG bearer should also pass through NR PDCP given that it is destined with Secondary Node which gNB.

The UE can interact with the network to exchange user data (or user plane) via Data Radio Bearers (DRBs) and control messages (or control plane) via Signaling Radio Bearers (SRBs). SRBS have higher data scheduling priority at the MAC layer compared to DRBs. Both DRBs and SRBs are setup and managed by the Radio Resource Control (RRC) layer.

All control plane messages are handled by the RRC protocol. All RRC messages terminate at the base station. UE can also interact with the core network over the NAS (Non-Access Stratum) signaling protocol which is transported by the RRC protocol. In other words, a NAS message is encapsulated within an RRC message which initially terminates at the base station and then relayed to the core network (i.e., AMF). The NAS messages may not be visible to the base station. The NAS messages will be carried over from the base station to AMF via the NGAP protocol. The AMF relays NAS messages which need to be delivered to SMF.

With 5G NR, there are four different SRBs as listed below:
SRB0 is used for transport of RRC messages associated with the common control (CCCH) logical channel. In SRB0, RRC messages are transported without any security, integrity, and encryption protection. It is typically used for transporting RRC messages such as RRCSetupRequest, RRCResumeRequest, etc.
SRB1 is used for transport of RRC messages including piggybacked NAS messages as well as NAS messages prior to the establishment of SRB2 where all are associated with a dedicated control logical channel. SRB1 is typically used for carrying RRC messages such as RRCReestablishement, RRCRelease, RRCResume, UEAssistanceInformation, etc. SRB1 supports segmentation/reassembly so a large control data can be carried over via multiple RRC packets.
SRB2 is for NAS messages and for RRC messages which include logged measurement information, all using DCCH logical channel. SRB2 has a lower priority than SRB1 and is always configured by the network after security activation.
SRB3 is for specific RRC messages when UE is in MR-DC, all using DCCH logical channel. SRB3 is an optional functionality to permit UE to interact with secondary node (SN) directly and it is requested to be setup by the SN. SRB3 is helpful in reducing signalling latency between UE and SgNB given that UE can directly interact with SgNB instead of going through the Master Node (either MgNB or MeNB). SRB3 may be configured for the transfer of some NR RRC messages between UE and SgNB (or SN) via the NR radio interface. Examples of such messages are MeasurementReport, RRCReconfiguration, ULInformationTransfer, etc.
SRB4 is for specific RRC messages to transport application layer measurement report information to gNB (the AppLayerMeasParameters-r17 Information Element (IE) in the RRC UECapabilityInformation message), mainly indicating application specific metrics such as UE's Quality of Experience (QoE) to the base station. SRB4 can only be configured by the network after AS security activation. SRB4 supports segmentation/reassembly similar to SRB1 so a large RRC message can be delivered over multiple RRC packets.

SRB1 is a higher priority than SRB2. SRB3 is of higher scheduling priority than all DRBs.

The default scheduling priorities of split SRB1 and SRB3 are the same. SRB1 and SRB2 can be configured for Split SRB (split SRB is not supported for SRB0 and SRB3) in all MR-DC configurations (e.g., EN-DC, NR-DC, etc.). A split SRB implies that RRC messages can be transferred using the MN, SN, or both. The latter case may significantly help to improve the reliability of the signaling message transportation in both UL and DL directions. RRC PDUs on split SRB is ciphered and integrity-protected using NR PDCP.

The priority of a Radio Bearer (RB) is currently defined between 1 and 16, where SRB1 and SRB3 (if configured) have the highest priority level (i.e., Priority 1) while SRB2 is the second highest priority (i.e., Priority 2) followed by SRB4. have a lower priority compared to SRBs. However, a DRB can have a higher priority compared to another DRB. With current NR standards, Priority 16 is the lowest, meaning the MAC layer will give the lowest priority in its data scheduling to PDUs at this priority level when other PDUs with higher priority compete for the limited share resources. In other words, the MAC layer prioritizes SRB's PDUs when they complete with DRB's PDUs for both uplink and downlink when available air interface resources are a constraint.

In summary, SRB0, SRB1 and SRB3 are mainly for delivering RRC signaling messages, SRB2 for NAS messages between UE and CN, and DRB for delivering data or user plane packets between UE and the application servers. Note should be taken that small user plane data packets can also be delivered over SRBs when UE is in the RRC INACTIVE state, a common configuration with Cellular Internet of Things (IoT) (CIoT) use cases.

5G New Radio (NR) includes three RRC states as follows: (i) RRC_CONNECTED; (ii) RRC_INACTIVE; and (iii) RRC_IDLE. In RRC_CONNECTED, UE is fully connected to the network with established SRBs and DRBs. When UE is in this state, both RAN and CN have allocated the required resources for this UE to be fully connected, which includes maintaining UE's context. Having the UE in this state is extremely non-energy efficient. For this reason, when UE is inactive for a certain predefined period of time, the network may change the UE's RRC state to either RRC_INACTIVE or RRC_IDLE.

When a UE enters RRC_INACTIVE, its established DRBs will be released, so there would not be any established PDU sessions to the CN (i.e., no data plane availability between UE and CN). However, SRBs are intact so that UE can still exchange control plane messages with the NG-RAN and CN. It is worth highlighting that in RRC_INACTIVE, connectivity between NG-RAN and CN is available.

The key motivation to have the RRC_INACTIVE state in NR is to save energy for UE while at the same time permitting UE to return back to the RRC_CONNECTED state with a small number of signalling messages (and thus with low latency). In this way, not only can UE enter this state more frequently to save more power but also can return back to a fully CONNECTED state with established DRBs setup quickly, which is essential for low latency applications.

In RRC_INACTIVE, UE can still send small user plane data to the network over established SRBs via the 3GPP Small Data Transmission (SDT) technology, which has been standardized for Cellular IoT use cases. These IoT devices are typically equipped with low battery capacity, and they typically require sending small data to the network infrequently.

When UE is in RRC_IDLE, it is disconnected from the network, and thus no resources are allocated for the UE in the RAN and CN. Returning back from RRC_IDLE to RRC_CONNECTED requires several signalling messages to be exchanged between UE, RAN, and CN (e.g., re-establishing security, establishing SRBs and DRBs, UE initial context setup, etc.). Entering RRC_IDLE is not well suited for latency-sensitive applications that may require transmitting user plane data to the network with low UL transmission delay. That said, utilizing this state effectively may optimize a significant amount of resources across the 3GPP system, including UE, RAN, and CN.

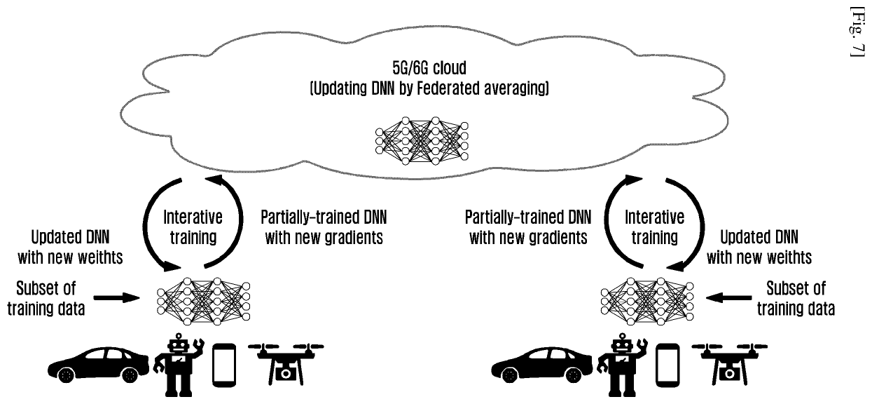

FIG. 6 shows the RRC state machine and state transition in NR. The RRC_INACTIVE is new in NR and it is a middle state between RRC_CONNECTED and RRC_IDLE.

Federated Learning (FL) participants must be able to complete and deliver their local model training to a central FL server in an acceptable time window. In some cases, this may become challenging when UE has low battery capacity or it is predicted that UE will be in a low battery status soon. This condition worsens as UE uses a Sidelink connection to one or more nearby devices, while also maintaining its cellular connectivity. Cellular connectivity consumes significant energy due to rapidly calling procedures such as Radio Link Monitoring (RLM), measurement and measurement reporting messages, PDCCH for UL/DL scheduling, etc. In other words, from a power consumption perspective, keeping UE in the RRC CONNECTED state is highly inefficient if not needed, which may be the case when connected to another UE over a direct device-to-device connection.

This invention tries to intelligently optimize power consumption for UEs willing to use Sidelink to continue an FL distributed mode training. This invention's problem statement may apply to other use cases of collaborative devices (e.g., V2X, XR, etc.).

Federated Learning (FL) is an important machine learning technique that allows a set of participants (UEs) to engage in distributed model training without exposing their own parameters (data) other than a set of weights to outside entities. It is predicted that FL will be significantly used in several 5G/6G use cases and thus, it generates a significant amount of traffic on 5G/6G networks. Therefore, it is important this it is handled gracefully within 3GPP networks.

FIG. 7 shows certain key interactions between the main entities involved in a distributed FL model training session. Participants can be a car, robot, smartphone, and drone and the central FL server may be located in a 5G/6G cloud within or outside the 3GPP network. It is worth highlighting that a central FL server may be located in other locations such as RAN, 5GC and/or UE, especially in a hierarchical FL model.

A general working principle of FL model training is as follows:
Participants advertise their willingness to be part of a training session.
The FL server selects a set of participants to be part of the next training cycle based on a set of criteria that may be dynamically changed between training cycles.
The FL server then distributes the latest trained global model to selected participants.
Each participant then starts its local model training when it receives the global model and its related configurations. The local training may use a particular or locally available dataset or real environment parameters.
Each participant then sends the trained model to the FL server once its local training is completed (i.e., when the local model is converged and is stable).
The FL server then aggregates all locally trained models from participants, creating a new global model which can be further distributed between participants in the next round of training sessions.

Synchronous Federated Learning (Sync-FL) is another form of FL where participants have a strict deadline for their local model training completion and also uploading the results to the central FL server. If a participant can't meet the deadline, its results (i.e., trained models) may be unused by the central FL server, wasting 3GPP resources across UE, RAN, and Core Network. On that basis, typically, the central FL server indicates these time constraints to participants so that their compute and network resources can be adjusted accordingly. That said, completing local model training at UE is also computationally intensive and thus requires a significant amount of power which is a curial resource, especially for mobile devices with limited battery capacity.

| | | Maximum latency | User experienced | |
|---|---|---|---|---|
| | | for trained gradient | UL/DL data rate for | |
| | GPU | uploading and | trained gradient | |
| Mini-batch | computation | global model | uploading and global | |
| size | time | distribution | model distribution | |
| (images) | (ms) | (see note 1) | (see note 2) | |
| 64 | 325 | 3.24 s | 325 | Mbit/s |
| 32 | 191 | 1.9 s | 55 | Mbit/s |
| 16 | 131 | 1.3 s | 810 | Mbit/s |
| 8 | 111 | 1.1 s | 960 | Mbit/s |
| 4 | 105 | 1.04 s | 1.0 | Gbit/s |

note 1:
Latency in this table is assumed 20 times the device GPU computation time for the given mini-batch size.
note 2:
Values provided in the table are calculative needs for an 8-bit VGG16 BN model with 132 MByte size, given mini-batch sizes and a duration of seconds per iteration. Necessary user experience UL/DL data rates can be reduced by e.g. setting longer times per iteration, applying compressed FL, or using another AI/ML model.

The table above shows latency and user experienced UL/DL data rates for uncompressed FL.

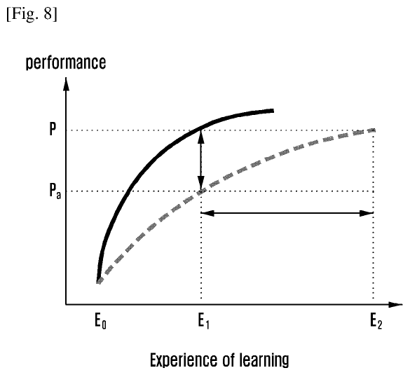

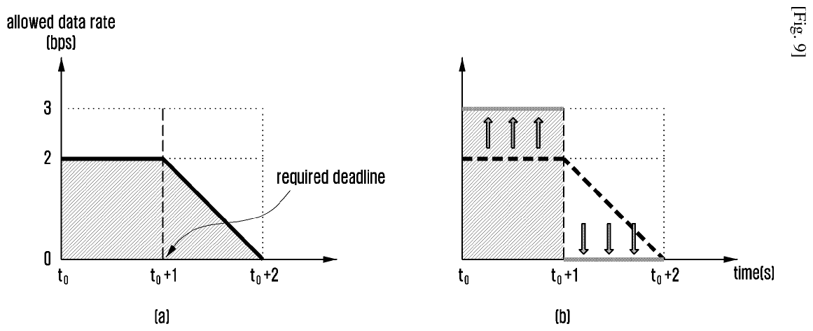

Sync-FL is a crucial example to highlight the importance of minimizing partial or total disturbance of data collection or data transfer for AI/ML operations. Another important scenario may be related to multi-agent, multi-device ML operations where, typically, a big data processing task (e.g., distributed training) is split amount a set of devices (UEs) by ML agents. FIG. 8 shows the achievable learning performance (i.e., Experience of Learning) towards a given task when data collection/transfer is distributed (shown by the dashed line) and not distributed (shown by the solid line). When AI/ML data (training results) is disturbed for any reason (and thus not arriving on time to its destination), it will directly influence learning performance, where the vertical and horizontal lines with arrows between these two lines shows this performance gap.

There may be several reasons that the AI/ML data (training results, etc.) may be disturbed and thus will not be arrived at its destination on time, for example:
Lack of network resources (e.g., radio resources due to temporal degradation, higher noise/interference level, highly crowded situations, partial/total break-down, and so on) preventing input data from being delivered in time.
Lack of computational resources at UE (e.g., GPU/CPU) at the time of training.
Lack of reach training dataset at UE.
Lack of power at UE during the course of the training

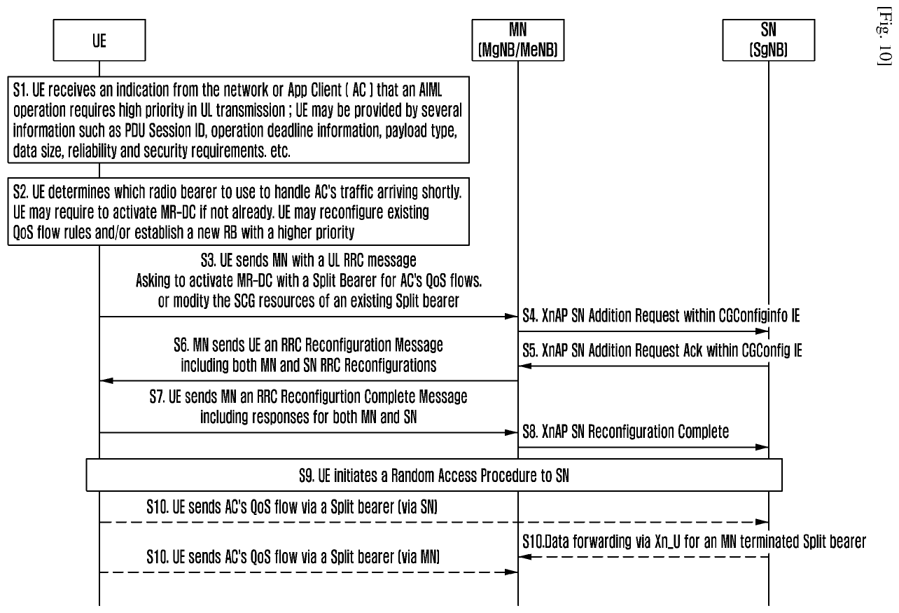

FIG. 9 shows a scenario where a UE attempts to prevent data disturbance by intelligently scheduling the UL data transmission for a particular set of bits so that the required UL data transmission deadline of one second is met. In FIG. 9 (a), the UE delivered the concerning data with a size of 3 bits in two seconds, which caused the UL transmission deadline of one second to be missed. Instead, in FIG. 9 (b), the UE used a higher data rate of 3 bps, delivering the concerning data in one second (meeting the UL transmission deadline of one second). In this way, not only can the UE meet its application requirements but also, between time t₀+1 and t₀+2, the base station has more resources to grant to other UEs for their UL transmission.

Some of the AI/ML service comprises time sensitive operations such as those in FL. For example, a central FL server distributes a training task to a set of devices (participants). The participant should run a training session with its local dataset or within its local environment. Once the model training is completed the participant delivers the results to the central FL server. All these steps should be completed within a specific time window. Otherwise, the results would not be considered by the central FL server for the next training cycle, wasting valuable 3GPP resources across UE, RAN, and CN, or causing a Flocking problem where the overall group performance of AI/ML service is directly related to the weakest member. The term “Flock” stands for a group that has performance requirements that consider the performance “as a team” as opposed to the ‘total’ or results of the ‘best performers. Synchronous Federated Learning (Sync-FL) could be a good example where the Flocking problem may occur.

It is worth highlighting that these types of workflows will be increasing on the 3GPP network given that the location of servers, hosting different services, are getting closer to end devices, and end devices can then engage in distributed computations. It is worth highlighting that these types of workflows (i.e., distributed processing) are already known among servers in datacenter networks where thousands of servers engage in a distributed computation (e.g., web search, Apache Hadoop). In the 3GPP system there are also collaborative devices which they may be able to engage in a distributed processing workflows.

There may be several factors where a distributed AI/ML task (e.g., Sync-FL model training) may fail to meet its task completion deadline and thus causing the Flocking problem:
Delays in delivering task metadata from a central FL server to a participant (e.g., an initial model which should be used by participants). This could be related to DL scheduling and/or poor radio condition.
Delays in completing the assigned task (i.e., model training) to a participant. This could be related to a sudden shortage of computational resources at the UE due to a lack of power and/or increasing demands on computing resources and/or issues with the training environment including poor training datasets, etc.
Delays in delivering the results to a central server. This could be related to poor UL scheduling and/or poor radio condition and/or lack of air interface resources at the base station due to network load, etc.

Delays related to the UL scheduling are the most crucial ones among the above items, given that the UE has already completed the training results and how the UL transmission should be scheduled dictates whether the UE can meet the task completion deadline or not. If the UE is delayed in completing its training, then it may require more priority in its UL transmission to compensate for those delays. If the size of its data (e.g., training results) is large, then it is better to use Split bearer to get a high aggregated throughput if the UE is configured with DC.

If the size of the data is small, it may be better to use SRB (e.g., SRB3 in a DC deployment) rather than a DRB (e.g., MCG/SCG bearer). Therefore, allocating appropriate SRB/DRB with suitable priority when UL data is ready to be transmitted is required. Currently, it is not feasible for the UE and/or network to know in advance when the UE has AI/ML results ready for UL transmission so that appropriate DRBs/SRBs are configured on time to deliver those results. Allocating a high-priority RB blindly by default to this sort of traffic at the PDU Session establishment may also not be efficient, provided that the AI/ML results may be ready well before the predefined deadline and the low-priority RB should be sufficient to deliver them on time. In other words, allocating a high-priority RB for application traffic unnecessarily may harm other competing traffic, at the serving cell, which actually needs high scheduling priority.

Particular problems include:
(Network based solutions with assistance information from the UE) How the UE can assist the network in deciding what type of radio bearer to configure for handling AI/ML traffic? This may include whether to activate DC and/or how to schedule AI/ML traffic across multiple DC's bearers (e.g., whether to use Split bearer, MCG/SCG bearer or a combination of them according to AI/ML application/service requirements).
(Network based solutions) How the network can (dynamically) configure the UE(s) with a suitable radio bearer type (e.g., SRB/DRB, Split DRB, or non-Split DRB, Split SRB, non-Split SRB or MCG/SCG) for handling AI/ML data, so that the UE(s) can meet their AI/ML model(s) learning requirements (e.g. model training completion deadline)?

Throughout this application, several assumptions are made regarding what the UE/Network can support:
Dual Connectivity deployment (e.g. MR-DC).
AI/ML framework.
RRC INACTIVE state.
Application clients running at UE can expose application specific information to radio protocol stack either directly or indirectly via another UE's components.
Application function (AF) or Application Server (AS) can expose information to UE either directly or indirectly via NAS signalling from 5GC.

According to the present invention there is provided an apparatus and method as set forth in the appended claims. Other features of the invention will be apparent from the dependent claims, and the description which follows.

According to a first aspect of the present invention, there is provide a method of performing bearer configuration for a particular class of data for a User Equipment, UE, communicatively coupled to a telecommunication network, wherein the bearer configuration is managed by the telecommunication network with or without assistance information from the UE, or by the UE itself.

In an embodiment, the particular class of data is associated with Artificial Intelligence, AI, or Machine Learning, ML.

In an embodiment, the telecommunication network is operating in a Dual Connectivity, DC, configuration.

In an embodiment, performing bearer configuration comprises mapping a bearer, remapping a bearer, configuring a new bearer, removing a bearer, selection or modifying a bearer type and wherein mapping a bearer comprises mapping a Quality of Service, QoS, flow to at least one bearer or mapping a bearer to at least one Protocol Data Unit, PDU, session or split PDU session.

In an embodiment, the UE informs the network of its capabilities, including its ability to engage in bearer configuration.

In an embodiment, the UE determines the bearer configuration required and requests that the network performs the associated bearer configuration.

In an embodiment, the UE requests that the network determined and configures an Uplink Quality of Service, QoS, flow mapping.

In an embodiment, the UE itself determines an Uplink Quality of Service, QoS, flow mapping and informs the network of the mapping.

In an embodiment, the UE or the Network determined a bearer configuration on the basis of a deadline to provide certain information.

In an embodiment, the UE determines to route the certain data over a particular DC bearer.

In an embodiment, the UE determines to activate DC or Carrier Aggregation to assist data flow for the certain data.

In an embodiment, the UE or the Network determines the bearer configuration on the basis of radio condition.

In an embodiment, the UE or the Network determines the bearer configuration on the basis of size, reliability or type of the certain data.

According to a second aspect of the present invention, there is provide an apparatus arranged to perform the method of the first aspect.

In an embodiment, the apparatus comprises at least a telecommunication network and a UE.

Furthermore:
All described embodiments may be applicable to other applications with similar or close workflows to AI/ML
Federated learning (FL) workflow has been used as a main AI/ML use case in this application. However, other AI/ML frameworks may exhibit a similar problem so the proposed solution in this disclosure is applicable to other such frameworks.
User Equipment (UE) and end-device are used interchangeably.
The described embodiments are applicable to all variants of dual connectivity (DC), whether described herein or not.

Certain key aspects of the present invention are:
UE indicates to NW its capabilities to support
   selection of RB type.
   remapping of QoS flows to RBs
UE determines a remapping for QoS flow and requests NW to perform/provide the required configurations.
UE asks NW to determine and configure a new UL QoS flow remapping for AI/ML operations in order to meet their requirements and constraints.
UE determines a new remapping and configures it by itself, and notifies NW.
UE or NW determines a RB (SRB/DRB) type according to the deadline information.
UE determines how to Split AI/ML traffic over a particular RB in MR-DC
UE provide recommendation or assistance information (e.g., information related to AI/ML application/service requirements) to the NW to assist the NW in deciding how to split AI/ML traffic over a particular RB in MR-DC.
UE determines to activate DC/CA if needed.
UE and/or NW determines an RB according to the radio condition of serving cells.
UE and/or NW determines an RB according to data size, reliability, and payload type.
UE and/or NW determines an RB according to the combination of parameters.

The above features ensure that the UE and/or NW can assist AI/ML application operations, particularly those related to federated learning to be completed on time by activating dual-connectivity and/or carrier aggregation, remapping AI/ML QoS flow to DRB to get higher UL transmission priority, transmitting AI/ML data over SRB, adjusting how AI/ML data should split across DC bearers in a Slit deployment, etc.).

Although a few preferred embodiments of the present invention have been shown and described, it will be appreciated by those skilled in the art that various changes and modifications might be made without departing from the scope of the invention, as defined in the appended claims.

The following embodiments are based on AI/ML task completion deadline, radio condition, data size, reliability.

In this embodiment, the UE indicates to the network about its capabilities, including radio bearer selection. The UE may indicate to the network that it is capable of engaging in (UL) radio bearer selection for AI/ML QoS flows or others. Additionally, the UE may indicate information of the UE capability to perform QoS remapping on UL radio bearers. These capabilities can be signaled during UE registration or PDU session establishment, or PDU session modification procedure via an RRC UE Capability Information message, e.g., within the UE-MRDC-Capability container or completely using a new IE (and/or new RRC or NAS signaling/messages). The UE capability may be stored in Unified Data Management (UDM), where other network functions and entities, can access or retrieve this information (directly or indirectly via other NW entities) if needed.

In another embodiment, UE determines a new remapping and asks network to perform required configurations. Here, the UE may be configured to determine a new remapping for AI/ML QoS flows to one or more specific DRB(s) for the UL direction. This configuration may be delivered by the UE by the network (e.g., it can be transported over a NAS message if configured by 5GC or via SRB if configured by the base station).

The UE may provide new UL remapping rules to the network and ask the network to configure the UE accordingly. For example, the network (MN/SN (e.g., gNB) or NG-RAN) may configure the desired QoS flows to DRB(s) remapping provided by the UE. In this solution, the network may reject the proposed mapping by the UE and configure the UE with a new remapping of its own determination. Signaling in this solution could be done, e.g., via a modified UL SDAP/PDCP control PDU, a new IE in an existing UL RRC message, or a new RRC message, etc.

In another embodiment, UE asks the network to determine and configure a new UL QoS flow remapping. Here, the UE may request the remapping configuration from a base station, using existing and/or newly defined RRC messages/signaling such as UE Assistance Information. The base station (gNB or NG-RAN) will then initiate an RRC procedure with the required setting (e.g., RRCReconfiguration procedure). For example, the UE may request the master RAN node to remap a particular QFI (QoS flow identifier) in a PDU Session to an existing SCG Split Bearer.

In another embodiment, the network configures a Reflective QoS functionality for an AI/ML QoS flow where the UL QoS flow will be mapped to the same radio bearer as DL. This way, if the DL bearer is changed for any reason, the UL will be changed according. Having such functionality will permit the UE to notify the network when it requires a new mapping for AI/ML and the network can reconfigure DL and in turn UL accordingly. To do so, the UE may signal this via SM (Session Management) Signaling by initiating a PDU session modification procedure. A new IE may need to be included in a NAS message so that the SMF will be informed.

In another embodiment, UE determines a new remapping and configure it by itself and notify the network. Here, the UE may be configured to remap the UL QoS rules itself to reflect a new mapping of a particular QFI to a DRB (e.g., DRBs in an MR-DC deployment) if needed. The UE may notify the network about its modifications accordingly. The notification may be signaled to the network in different ways, e.g., via a modified UL SDAP/PDCP control PDU, a new IE in a UL RRC message, etc.

The network may respond to the UE to agree or reject the UE's modification. In the latter case, the UE may update the UL QoS rules to their original state. To do so, the UE may keep a history of its (UL QoS rules) updates.

In the rejection case, the network may provide a suitable cause value for the rejection, e.g. “UL QoS rule update not allowed” or other cause value. Additionally, the notification from the network to the UE may be signaled via a modified DL SDAP control PDU, DL PDCP control PDU, an RRCReconfiguration message with a desired new mapping accepted by the network, etc.

In another embodiment, UE or NW determines a radio bearer (SRB/DRB) according to the deadline information. Here, the UE determines to use an SRB to transmit AI/ML data, given that an SRB has higher scheduling priority compared to DRBs at the MAC layer. This may be especially crucial when the UE is in RRC_INACTIVE with low battery power. A note should be taken that the UE being in RRC_CONNECTED in an MR-DC deployment has high energy consumption due to procedures, such as RLM, measurements and measurement reporting, and PDCCH for UL/DL scheduling, that needs to be frequently called for serving cells (i.e., MN and SN). Therefore, it may be power efficient for the UE to stay in RRC_INACTIVE and one viable approach to do this is to use an SRB for transmitting uplink data instead of DRB. The UE may follow a SDT procedure where the UL data could be transmitted to the base station over an RRCResumeRequest message. The SDT functionality should be enabled on a radio bearer and the UE can use it with no coordination with the base station.

In a related embodiment, the UE may ask the network to setup an optional SRB3 to SN so that the UE can directly send its AI/ML results to SN over SRB3 to reduce latency. Apart from the highest scheduling priority of SRB3, this scenario may be crucial when the AI/ML server is actually hosted on SN or close to SN so interactions with UPF (i.e., DRB) may not be needed.

In another embodiment, the UE may be configured by the network with a set of thresholds (related to time) to determine which RB type to use for sending AI/ML related data according to the time left before the deadline is missed. For example, the UE is configured with an EN-DC deployment where the MN is eNB and SN is gNB. The UE may be configured as follows:
Use SRB1 to MN or SRB3 to SN if the remaining time until the deadline is below threshold 1 (e.g., in ms). Note that the decision to whether SRB1 or SRB3 should be used needs further consideration of other factors such as radio condition to each serving cell, DC deployment model, available frequency and capacity with each serving cell, etc. This option provides the highest scheduling priority at the MAC layer.
Use SRB2 to MN if the remaining time until the deadline is between threshold 1 and threshold 2
Use SRB4 to MN if the remaining time until the deadline is between threshold 2 and threshold 3
Use SCG bearer to SN if the remaining time until the deadline is between threshold 3 and threshold 4
Use MCG bearer to MN if the remaining time until the deadline is between threshold 4 and threshold 5
Use Split bearer to both SN and MN if the remaining time until the deadline is above threshold 5. Note should be taken that this option may provide low latency and high data rate when the remaining time to the deadline is tight in the case of NR-DC where both serving cell is gNB.

In one embodiment, the UE may ask the network to determine and configure a radio bearer (e.g., SRB) for a QoS flow or a set of PDUs of a QoS flow to be used by the UE and/or network in exchange for AI/ML model(s) and/or related data in a DC deployment. This way, the network may regularly collect a set of data, analytics, statistics, etc., from the UE or elsewhere. In one example, the UE collects the required data and analytics from UE either from the UE directly or from 5GC (e.g., by subscribing to related NWDAF instances) or both. The network may then initiate an RRC Reconfiguration procedure to apply new configurations at the UE.

In an embodiment, UE determines how to Split AI/ML traffic over a particular MR-DC radio bearer. Here, the UE supports MR-DC deployment, and it determines to transmit all data related to AI/ML model and/or AI/ML data via MCG bearer, SCG bearer, Split bearer, and/or any combination of those bearers.

In one embodiment, the UE may adjust the threshold of the ul-DataSplitThreshold parameter to determine what fraction of AI/ML PDUs should be split to the MN and the SN based on the amount of time left for the AC to meet its task completion deadline. For example, the UE may move all its (AI/ML) PDUs to SN (which operates over FR2) by making SCG as primary cell group and increasing the value of the ul-DataSplitThreshold parameter.

A note should be taken that the ul-DataSplitThreshold parameter is the only 3GPP standardized parameter for controlling how PDUs should be distributed in a Split bearer.

In one embodiment, the exact fraction of data going on MN or SN is decided by the UE according to some algorithm whereby the network signals a maximum or minimum limit range. For instance, the network may signal that a maximum of 20% of traffic may go over the MN, while a minimum of 80% shall go over SN.

In another embodiment, the network configures multiple thresholds to use in certain cases of high priority data arriving. One threshold is used for normal traffic and if high priority data arrives, a secondary ul-DataSplitThresholdHighPriority is used. The activation of the secondary threshold can for instance be activated by PDCP itself, or may be activated as an indication from RRC, higher layers or even application layers.

In another embodiment, the UE may employ an ML algorithm to assist in how the AI/ML traffic should be split across multiple base stations in an MR-DC deployment. This way, the output of the ML algorithm could be a weight or a set of weights dictating what fraction of data should be delivered in each base station. The splitting weight(s) could be defined in different granularities. For example, it could be per QoS flow, PDU session, or multiple PDU sessions (i.e., across all UE's traffic).

In an embodiment, UE determines to activate DC/CA if needed. Here, the UE is already connected to MN (e.g., via the MgNB) and upon receiving application-specific feedback information, it determines that further cellular connectivity may assist the AI/ML flow in handling its traffic special situation gracefully. On that basis, the UE asks the MN to initiate the XnAP S-Node Addition procedure towards another base station (SgNB) to form a DC for faster UL transmission. For MN to select a suitable SN for the UE, the MN is required to have all UE measurements towards potential SNs.

The signaling in this solution could be defined via a new IE within an existing RRC message, such as Measurement Report, UE Assistance Information or a new UL RRC message.

In another related configuration, the UE may request the network to activate carrier aggregation over DC bearers (e.g., MCG or SCG bearers). This way, the aggregated capacity of each bearer (cell group) will be increased significantly.

In an embodiment, UE or NW determines a radio bearer according to radio condition. Here, a UE may consider the radio condition of each serving cell in a MR-DC deployment to determine which is the best radio bearer to use for handling AI/ML traffic given their requirements and constraints. There are several measurement parameters that UE may use to predict radio condition of each serving cell, for example, SINR, RSRP, etc. Other UE's conditions such as handover could also be considered for these predictions.

In one embodiment, the UE may follow a certain threshold related to signal level in an NR-DC deployment as follows:
Use Split bearer when the signal level is above a certain threshold (e.g., threshold X). It is worth highlighting that when the radio condition is good with all serving cells then a Split bearer could be a good option to achieve a high UL data rate with low latency.
Use MCG bearer when the signal level of MN is below the threshold X and SN is above the threshold X
Use SCG bearer when the signal level of SN is below the threshold X and MN is above the threshold X

In one scenario, the UE may use other factors in addition to the signal level to decide which (DC) bearer to use. For example, the UE may use an SCG bearer when the signal is closely similar from UE to SN and MN but the number of retransmissions at the MAC and/or RLC layer of the SCG bearer is less than the MCG bearer.

In another scenario, the UE may use the MCG bearer when the signal is similar from the UE to MN and the UE to SN, but the UE is predicted that the SCG bearer may enter into a handover condition when the AI/ML data becomes available for the UL transmission.

In another scenario, the UE determines to use the SCG bearer because it predicts that the MCG bearer would be loaded by other UE's applications traffic. The UE may consider load per bearer and/or across multiple bearers and/or across all bearers (via BSR) and/or per PDU session. It is worth highlighting that all radio bearers in MR-DC are associated with one or more PDU Session(s). This also implies that multiple QoS flows of a single PDU session could be mapped to any bearer associated with that PDU session.

A note should be taken that all the above determinations can be performed by the network (e.g., gNB) provided that the UE provides all required information to the network.

In an embodiment, UE or NW determines a radio bearer according to AI/ML data size, reliability and type. Here, the UE may decide to configure its QoS flows to different radio bearers where flows with a small number of packets use either MCG or SCG bearer while flows with a large number of PDUs use Split bearer.

In one embodiment, the UE may determine a radio bearer configuration according to the data reliability requirements. For example, if the UE is informed that the incoming AI/ML PDUs in the next X ms should be transmitted with high reliability, the UE may remap the corresponding QFI to a Split bearer with activated packet duplication. Alternatively, the UE may reconfigure the MR-DC bearers where a particular QFI is primarily delivered by MCG while its duplicated packets are delivered via SCG bearer.

In one embodiment, the UE may reconfigure an MR-DC radio bearer with RLC AM (Acknowledge Mode). This way, if the AI/ML packets get dropped, they can be retransmitted by the RLC layer as well as other lower layers.

In another embodiment, none of the existing MR-DC bearers have been configured with RLC-AM, so the UE may ask the base station (e.g., MgNB) to add another DRB with RLC AM as an MCG or SCG bearer. The UE may ask gNB for a higher priority for this new DRB with RLC-AM, ensuring only data will be retransmitted if lost, but also data gets higher scheduling priority at the MAC layer when competing with other traffic in limited resource availability.

In one embodiment, the UE may configure different AI/ML payload types to different MR-DC radio bearers. For example, the data PDUs related to AI/ML application metadata (e.g., training configurations or other control messages) can be mapped to a high-priority DRB or SRB (e.g., SRB1, SRB2, or SRB4 via MN or SRB3 via SN), while training results (e.g., neural network weights) and/or datasets may be mapped to an MR-DC bearer such as a Split DRB.

A note should be taken that all the above determinations can be performed by the network (e.g., gNB) provided that the UE provides all required information to the network.

In an embodiment, UE or NW determines a radio bearer according to combination of parameters. Here, the UE may be configured to determine which MR-DC bearers to use given a combination of parameters such as the time sensitivity of the UL transmission, payload type, data size, data security, integrity and reliability requirements, user mobility, RRC state, available resources, MR-DC deployment model, etc. For example, a UE may select a different radio bearer in an EN-DC scenario compared to NR-DC when the data size is large and the UL transmission is time sensitive with a strict requirement for reliability.

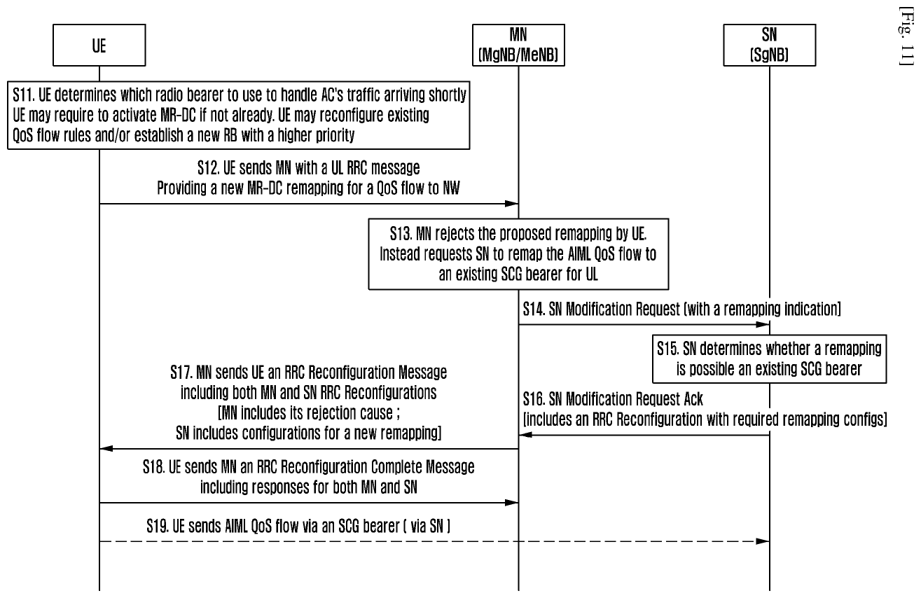

FIG. 10 illustrates an example call flow to activate DC initiated by the UE. In particular, it demonstrates UE steps required to activate the Split bearer (MR-DC) for an AI/ML QoS flow. Steps are described as follows:

In Step S1: The UE receives an indication from the network (e.g., from dedicated AI/ML AF) or APP Client (AC) running at UE that an AI/ML operation requires high priority in UL data transmission, arriving at UE's PDCP buffer in X ms. The UE may be informed with the following information: PDU Session ID, deadline information concerning the ML operation, the payload type (e.g., whether it is related to training results, training configurations or datasets), data size, reliability, and security requirements, etc. to the UE.

In Step S2: The UE then determines which radio bearer to use for handling AC's traffic arriving shortly (e.g., in X ms). The UE may be required to activate (or request activation from MN) a secondary RAN node (SN) if not already done so. The UE may reconfigure existing UL QoS flow rules and/or establish a new RB either between UE and MN (MCG) or UE and SN (SCG) with a higher priority. The UE may decide to use an SRB instead of a DRB for handling the concerning AI/ML PDUs if needed.

Note: The UE can reconfigure AI/ML QoS flows to DRBs at the SDAP layer either by itself or by the network. However, the UE may need to follow an SDT procedure if an SRB needs to be used.

In Step S3: The UE may request the MN to activate an MCG Split bearer for AC's QoS flows in the UL direction. As part of this activation, the MN requires to select a target SN based on the measurement report received by the UE. Alternatively, the UE may request the network to modify the SCG resources of an existing MCG Split bearer. The signaling in this step could be handled over SRB1 towards MN. However, if SRB3 is established between UE and SN, the UE can directly request SN for SCG resource reconfigurations. The UE may use an existing UL RRC message, such as UE Assistance Information, a new UL RRC message, or an RRC Measurement Report message.

In Step S4: The MN decides to request the target SN to allocate resources for one or more specific PDU Sessions/QoS Flows, indicating QoS Flows characteristics (QoS Flow Level QoS parameters, PDU session level TNL address information, etc.). In addition, for bearers requiring SCG radio resources, such as an MCG Split Bearer, MN indicates the requested SCG configuration information, including the entire UE capabilities and the UE capability coordination result. In this case, the MN also provides the latest measurement results from UE for SN to choose and configure the SCG cell(s). On that basis, MN initiates the Secondary Node (SN) Addition procedure to establish a UE context at the SN in order to provide resources from the SN to the UE. For bearers requiring SCG radio resources (e.g., MCG Split Bearer), this procedure is used to add at least the initial SCG serving cell of the SCG.

Note: The MN exchange control messages over the XnAP protocol operating over the Xn interface between MN and SN.

In Step S5: The SN may allocate respective radio resources requested by MN. For bearers requiring SCG radio resources, the SN triggers UE Random Access so that synchronization of the SN radio resource configuration can be performed (see Step S9). The SN indicates this within the reconfigurationWithSync IE of the SN RRC Reconfiguration message.

In Step S6: The MN sends to the UE an MN RRCReconfiguration message which includes the SN RRC configuration message received from SN over XnAP, without modifying it.

In Step S7: The UE replies to MN with MN RRC reconfiguration complete message, including an SN RRC response message for SN.

In Step S8: The MN informs the SN that the UE has completed the RRC reconfiguration procedure successfully, including the SN RRC response message over the XnAP protocol, if received from the UE.

In Step S9: If SCG radio resources are required, which is the case in this example, the UE initiates a Random Access Channel (RACH) Procedure with synchronization towards the PSCell configured by the SN. Note that the RACH procedure can be triggered in a different order, e.g., after Step S6 rather than after Step S8.

In Step S10: The UE starts its UL transmission of AC PDUs over a newly configured MCG Split bearer.

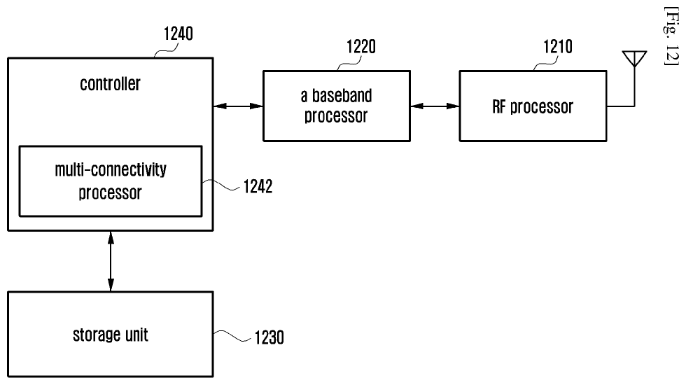

Another embodiment remaps AI/ML QoS flow to an MR-DC bearer initiated by the UE and rejected by the MN. FIG. 11 demonstrates UE steps required to remap a QFI-DRB in an MR-DC deployment. Steps are described as follows:

In Step S11: The UE determines which radio bearer to use for handling AC's traffic arriving shortly (e.g., in X ms). The UE may reconfigure existing UL QoS flow rules so that the AI/ML QFI can be mapped to a new DRB (e.g., either MCG bearer or SCG bearer or Split Bearer). In this example, the UE determines to remap the AI/ML QoS flow to a Split bearer.

Note: In this example, all possible MR-DC bearers have already been established within a PDU session that this AI/ML QoS flow is associated with.

In Step S12: The UE sends MN its desired remapping for AI/ML QoS flow. To do so, the UE may use an existing UL RRC message, such as UE Assistance Information, a new UL RRC message, etc. The UE may also use SDAP/PDCP control PDU for this purpose. The header of the UL SDAP/PDCP control PDUs may need to be extended to support this signaling.

In Step S13: The MN may reject the UE's proposed remapping. The MN may or may not reply to the UE with the rejection and a suitable cause of this rejection. Additionally, the MN determines to forward the UE remapping request to SN or ask SN whether the concern QoS flow (QFI) can be mapped to an existing bearer (e.g. SCG bearer) of SN. The SN may or may not acknowledge whether it is possible to fulfil the UE request.

In Step S14: The MN sends the SN Modification Request message, asking SN to remap the AI/ML QoS flow to an SCG bearer.

In Step S15: The SN may accept to reject the request of MN. For example, the SN may provide a suitable cause value for the rejection (e.g. NoRemappingAllowed, RemappingNotSuitable, any other names). If accepted, the SN then determines which SCG bearer to map this QoS flow. If there is no SCG bearer, SN may ask UE to establish one.

In Step S16: The SN responds with the SN Modification Request Acknowledge message, which may contain new SCG radio configuration information within an SN RRC reconfiguration message, and data forwarding address information (if applicable). If the MN requests the SCG to be activated or deactivated, the SN indicates whether the SCG is activated or deactivated.

In Step S17: The MN initiates the RRC reconfiguration procedure, including an SN RRC reconfiguration message. The MN RRC reconfiguration procedure may include cause for the rejection of the UE's proposed remapping.

In Step S18: The UE applies the new configuration, synchronizes to the MN (if instructed, in case of intra-MN handover) and replies with MN RRC reconfiguration complete message, including an SN RRC response message, if needed. In case the UE is unable to comply with (part of) the configuration included in the MN RRC reconfiguration message, it performs the reconfiguration failure procedure.

In Step S19: The UE starts using the configured SCG bearer by the SN for the AI/ML QoS flow in the UL direction.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

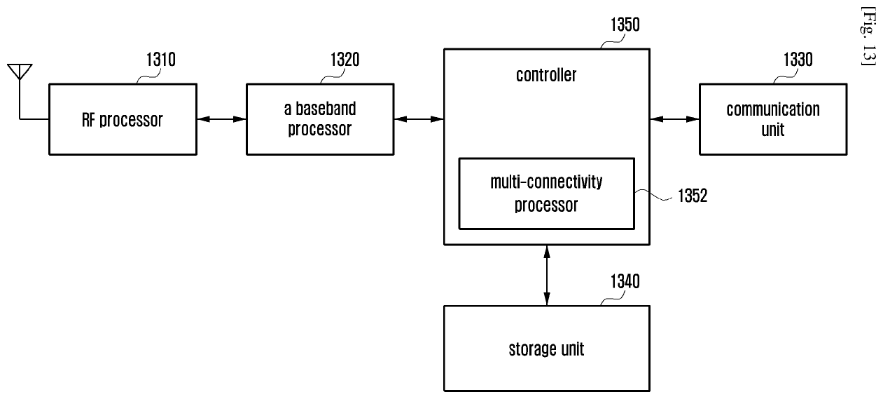

FIG. 12 illustrates a user equipment (UE) in a wireless communication systems to which embodiments of the disclosure can be applied

Referring to FIG. 12, the UE includes a radio frequency (RF) processor 1210, a baseband processor 1220, a storage unit 1230, and a controller 1240.

The RF processor 1210 performs a function for transmitting and receiving a signal through a wireless channel, such as band conversion and amplification of a signal. That is, the RF processor 1210 up-converts a baseband signal provided from the baseband processor 1220 into an RF band signal, transmits the RF band signal through an antenna, and then down-converts the RF band signal received through the antenna into a baseband signal. For example, the RF processor 1210 may include a transmission filter, a reception filter, an amplifier, a mixer, an oscillator, a digital-to-analog converter (DAC), an analog-to-digital converter (ADC), and the like. Although FIG. 12 illustrates only one antenna, the UE may include a plurality of antennas. In addition, the RF processor 1210 may include a plurality of RF chains. Moreover, the RF processor 1210 may perform beamforming. For the beamforming, the RF processor 1210 may control a phase and a size of each signal transmitted/received through a plurality of antennas or antenna elements. The RF processor may perform MIMO and receive a plurality of layers when performing the MIMO operation. The RF processor 1210 may appropriately configure a plurality of antennas or antenna elements according to the control of the controller to perform reception beam sweeping or control a direction of a reception beam and a beam width so that the reception beam corresponds to a transmission beam.

The baseband processor 1220 performs a function for a conversion between a baseband signal and a bitstream according to a physical layer standard of the system. For example, when data is transmitted, the baseband processor 1220 generates complex symbols by encoding and modulating a transmission bitstream. Further, when data is received, the baseband processor 1220 reconstructs a reception bitstream by demodulating and decoding a baseband signal provided from the RF processor 1210. For example, in an orthogonal frequency division multiplexing (OFDM) scheme, when data is transmitted, the baseband processor 1220 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 1220 divides the baseband signal provided from the RF processor 1210 in the unit of OFDM symbols, reconstructs the signals mapped to the subcarriers through a fast Fourier transform (FFT) operation, and then reconstructs a reception bitstream through demodulation and decoding.

The baseband processor 1220 and the RF processor 1210 transmit and receive signals as described above. Accordingly, the baseband processor 1220 and the RF processor 1210 may be referred to as a transmitter, a receiver, a transceiver, or a communication unit. Further, at least one of the baseband processor 1220 and the RF processor 1210 may include a plurality of communication modules to support a plurality of different radio access technologies. In addition, at least one of the baseband processor 1220 and the RF processor 1210 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 1230 stores data such as basic program, an application, and setting information for the operation of the UE. The storage unit 1230 provides the stored data according to a request from the controller 1240.

The controller 1240 controls the overall operation of the UE. For example, the controller 1240 transmits/receives a signal through the baseband processor 1220 and the RF processor 1210. In addition, the controller 1240 may record data in the storage unit 1230 and read the data. To this end, the controller 1240 may include at least one processor. For example, the controller 1240 may include a communication processor (CP) that performs a control for communication, and an application processor (AP) that controls a higher layer such as an application program.

FIG. 13 illustrates a base station in a wireless communication system to which embodiments of the disclosure can be applied.

As illustrated in FIG. 13, the base station includes an RF processor 1310, a baseband processor 1320, a backhaul communication unit 1330, a storage unit 1340, and a controller 1350.

The RF processor 1310 performs a function for transmitting and receiving a signal through a wireless channel, such as band conversion and amplification of a signal. That is, the RF processor 1310 up-converts a baseband signal provided from the baseband processing unit 1320 into an RF band signal and then transmits the converted signal through an antenna, and down-converts an RF band signal received through the antenna into a baseband signal. For example, the RF processor 1310 may include a transmission filter, a reception filter, an amplifier, a mixer, an oscillator, a DAC, and an ADC. Although FIG. 13 illustrates only one antenna, the first access node may include a plurality of antennas. In addition, the RF processor 1310 may include a plurality of RF chains. Moreover, the RF processor 1310 may perform beamforming. For the beamforming, the RF processor 1310 may control a phase and a size of each of the signals transmitted and received through a plurality of antennas or antenna elements. The RF processor may perform a downlink MIMO operation by transmitting one or more layers.

The baseband processor 1320 performs a function of performing conversion between a baseband signal and a bitstream according to a physical layer standard of the first radio access technology. For example, when data is transmitted, the baseband processor 1320 generates complex symbols by encoding and modulating a transmission bitstream. Further, when data is received, the baseband processor 1320 reconstructs a reception bitstream by demodulating and decoding a baseband signal provided from the RF processor 1310. For example, in an OFDM scheme, when data is transmitted, the baseband processor 1320 may generate complex symbols by encoding and modulating the transmission bitstream, map the complex symbols to subcarriers, and then configure OFDM symbols through an IFFT operation and CP insertion. In addition, when data is received, the baseband processor 1320 divides a baseband signal provided from the RF processor 1310 in units of OFDM symbols, recovers signals mapped with sub-carriers through an FFT operation, and then recovers a reception bitstream through demodulation and decoding. The baseband processor 1320 and the RF processor 1310 transmit and receive signals as described above. Accordingly, the baseband processor 1320 and the RF processor 1310 may be referred to as a transmitter, a receiver, a transceiver, or a communication unit.

The communication unit 1330 provides an interface for communicating with other nodes within the network.

The storage unit 1340 stores data such as a basic program, an application, and setting information for the operation of the MeNB. Particularly, the storage unit 1340 may store information on bearers allocated to the accessed UE and the measurement result reported from the accessed UE. Further, the storage unit 1340 may store information on a reference for determining whether to provide multiple connections to the UE or stop the multiple connections. In addition, the storage unit 1340 provides data stored therein according to a request from the controller 1350.

The controller 1350 controls the overall operation of the MeNB. For example, the controller 1350 transmits and receives a signal through the baseband processor 1320 and the RF processor 1310 or through the backhaul communication unit 1330. In addition, the controller 1350 may record data in the storage unit 1340 and read the data. To this end, the controller 1350 may include at least one processor.

Although the present disclosure has been described with various embodiments, various changes and modifications may be suggested to one skilled in the art. It is intended that the present disclosure encompass such changes and modifications as fall within the scope of the appended claims.

1. A method performed by a user equipment (UE) in a wireless communication system, the method comprising:
receiving, from an application function (AF), an indication for a high priority in an artificial intelligent (AI) or a machine learning (ML);
based on the indication, determining a radio bearer (RB) associated with a secondary cell group (SCG) for the AI or the ML; and
transmitting, to the secondary node (SN), uplink (UL) data over the RB associated with the SCG.

2. The method of claim 1, further comprising:
transmitting, to a master node (MN), a request message for SCG radio resources; and
receiving, from the MN, a radio resource control (RRC) message for configuring the RB associated with the SCG for the AI or the ML,
wherein the SCG radio resources is associated with a master cell group (MCG) split bearer.

3. The method of claim 1,
wherein the indication indicates that an operation of the AI or the ML requires the high priority in a UL data transmission.

4. The method of claim 1,
wherein the indication includes at least one protocol data unit (PDU) session identifier (ID), operation deadline information, a payload type, a data size, a reliability, or a security requirement.

5. A method performed by a master node (MN) in a wireless communication system, the MN comprising:
receiving, from a user equipment (UE), a request message for a secondary cell group (SCG) radio resources; and
transmitting, to the UE, a radio resource control (RRC) message for configuring a radio bearer (RB) associated with the SCG for an artificial intelligent (AI) or a machine learning (ML),
wherein the RB associated with the SCG is determined based on an indication for a high priority in the AI or the ML.

6. The method of claim 1, further comprising:
transmitting, to a secondary node (SN), a SN addition request message for the SCG radio resources; and
receiving, from the SN, a SN addition request response message including information for configuring the RB associated with the SCG for the AI or the ML,
wherein the SCG radio resources is associated with a master cell group (MCG) split bearer.

7. The method of claim 1,
wherein the indication indicates that an operation of the AI or the ML requires the high priority in a UL data transmission.

8. The method of claim 1,
wherein the indication includes at least one protocol data unit (PDU) session identifier (ID), operation deadline information, a payload type, a data size, a reliability, or a security requirement.

9. A user equipment (UE) in a wireless communication system, the UE comprising:
a transceiver; and
a controller configured to:
receive, from an application function (AF), an indication for a high priority in an artificial intelligent (AI) or a machine learning (ML), based on the indication, determine a radio bearer (RB) associated with a secondary cell group (SCG) for the AI or the ML, and
transmit, to the secondary node (SN), uplink (UL) data over the RB associated with the SCG.

10. The UE of claim 9, wherein the controller is further configured to:
transmit, to a master node (MN), a request message for SCG radio resources, and
receive, from the MN, a radio resource control (RRC) message for configuring the RB associated with the SCG for the AI or the ML,
wherein the SCG radio resources is associated with a master cell group (MCG) split bearer.

11. The UE of claim 9,
wherein the indication indicates that an operation of the AI or the ML requires the high priority in a UL data transmission.

12. The UE of claim 9
wherein the indication includes at least one protocol data unit (PDU) session identifier (ID), operation deadline information, a payload type, a data size, a reliability, or a security requirement.

13. A master node (MN) in a wireless communication system, the MN comprising:
a transceiver; and
a controller configured to:
receive, from a user equipment (UE), a request message for a secondary cell group (SCG) radio resources, and
transmit, to the UE, a radio resource control (RRC) message for configuring a radio bearer (RB) associated with the SCG for an artificial intelligent (AI) or a machine learning (ML),
wherein the RB associated with the SCG is determined based on an indication for a high priority in the AI or the ML.

14. The MN of claim 13, wherein the controller is further configured to:
transmit, to a secondary node (SN), a SN addition request message for the SCG radio resources, and
receive, from the SN, a SN addition request response message including information for configuring the RB associated with the SCG for the AI or the ML,
wherein the SCG radio resources is associated with a master cell group (MCG) split bearer.

15. The MN of claim 13,
wherein the indication indicates that an operation of the AI or the ML requires the high priority in a UL data transmission, and
wherein the indication includes at least one protocol data unit (PDU) session identifier (ID), operation deadline information, a payload type, a data size, a reliability, or a security requirement.
